(19) United States
(12) Patent Application Publication
(10) Pub. No.: US 2026/0021688 A1
(43) Pub. Date: Jan. 22, 2026

(54) VEHICLE MODE CONTROL MANAGEMENT

(71) Applicant: Ford Global Technologies, LLC, Dearborn, MI (US)

(72) Inventors: Jonathan Hair, Northville, MI (US); Lars Niklas Pettersson, Novi, MI (US)

(21) Appl. No.: 18/776,783

(22) Filed: Jul. 18, 2024

(51) Int. Cl. B60H 1/00; B60W 20/11; B60W 20/12

(52) U.S. Cl. CPC B60H 1/004; B60W 20/11; B60W 20/12

(57) ABSTRACT

Systems and methods for operating a hybrid vehicle are presented. In one example, the hybrid vehicle may include a plurality of devices for heating a passenger cabin of the hybrid vehicle. A vehicle drive mode may be engaged at an onset of a trip to a predetermined destination so that the passenger cabin may be heated and the vehicle may operate efficiently.

### FIELD

The present description relates to methods and a system for reducing a financial expense of operating a hybrid vehicle that includes a plurality of passenger cabin heating devices.

### BACKGROUND

A hybrid vehicle may include an internal combustion engine and an electric machine to propel the hybrid vehicle. The hybrid vehicle may operate in an electric machine exclusive mode where the hybrid vehicle may be propelled solely via an electric machine. The hybrid vehicle may also operate in an internal combustion engine exclusive mode where the hybrid vehicle may be propelled solely via the internal combustion engine. Further, the hybrid vehicle may operate in a blended internal combustion engine and electric machine driving mode where the vehicle may be propelled via the internal combustion engine and the electric machine. These modes may be entered and exited in response to a battery state of charge (SOC), but the financial expense of operating the vehicle according to the SOC may not be as optimal as may be desired.

It may be understood that the background above is provided to introduce in simplified form a selection of concepts that are further described in the detailed description. It is not meant to identify key features of the claimed subject matter, the scope of which is defined specifically by the claims that follow the detailed description. Furthermore, the claimed subject matter is not constrained to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an engine;

FIG. 2 is a schematic diagram of a hybrid vehicle driveline including the engine of FIG. 1;

FIG. 3 is a schematic of an example heating, ventilation, and air conditioning system for operating the hybrid vehicle;

FIGS. 4 and 5 show flowcharts of methods for operating the hybrid vehicle; and

FIG. 6 shows an example vehicle operating sequence.

### DETAILED DESCRIPTION

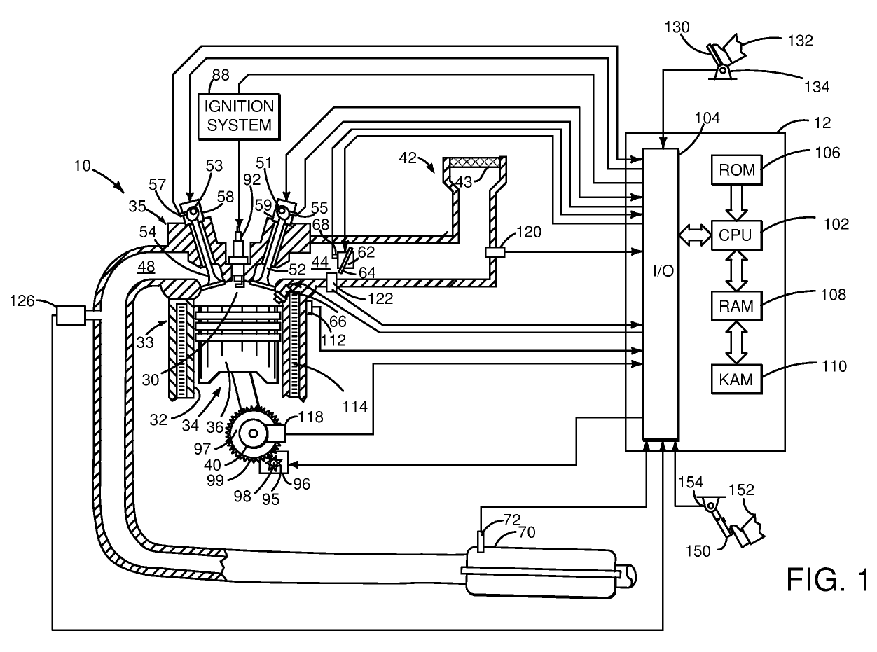

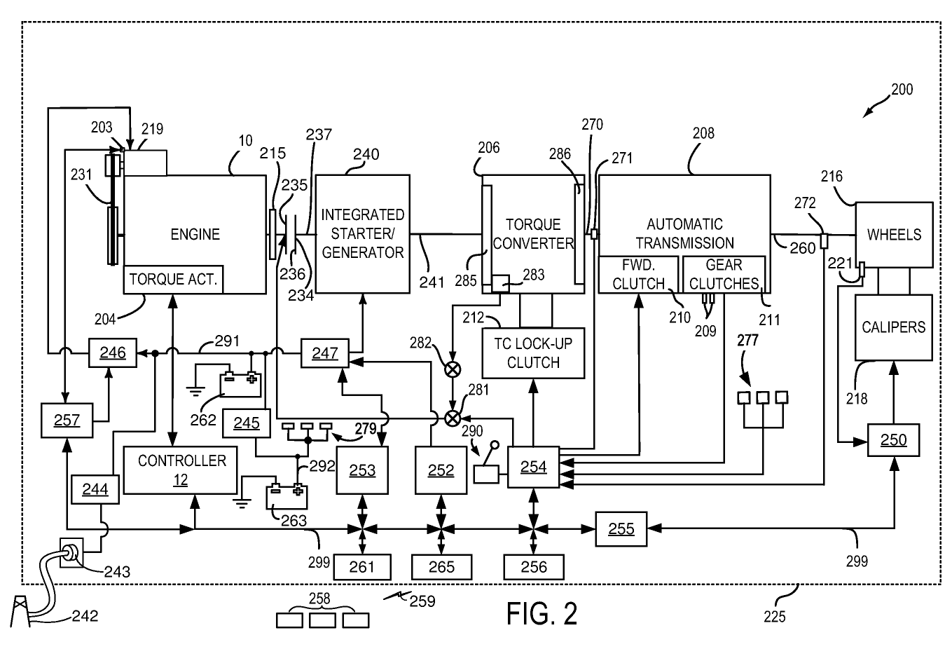

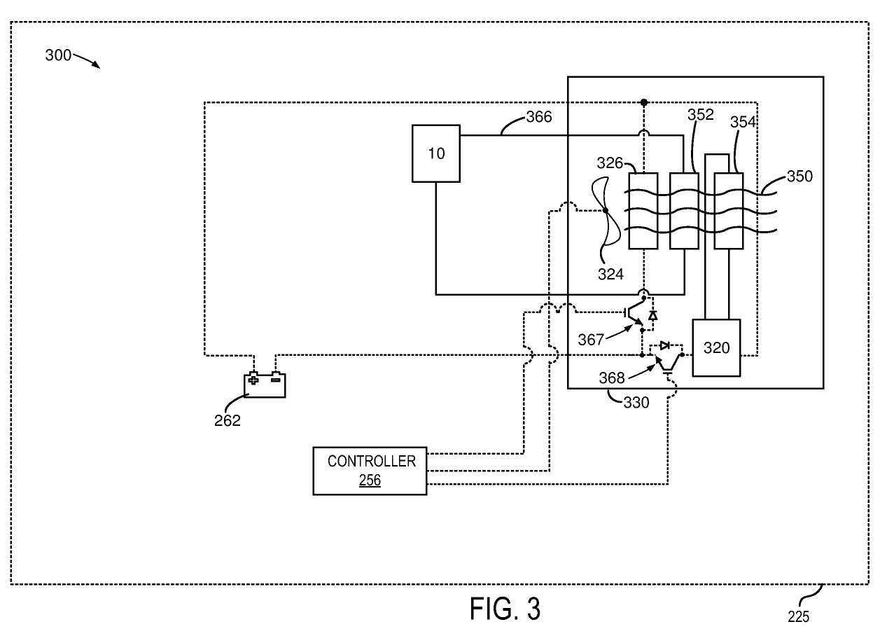

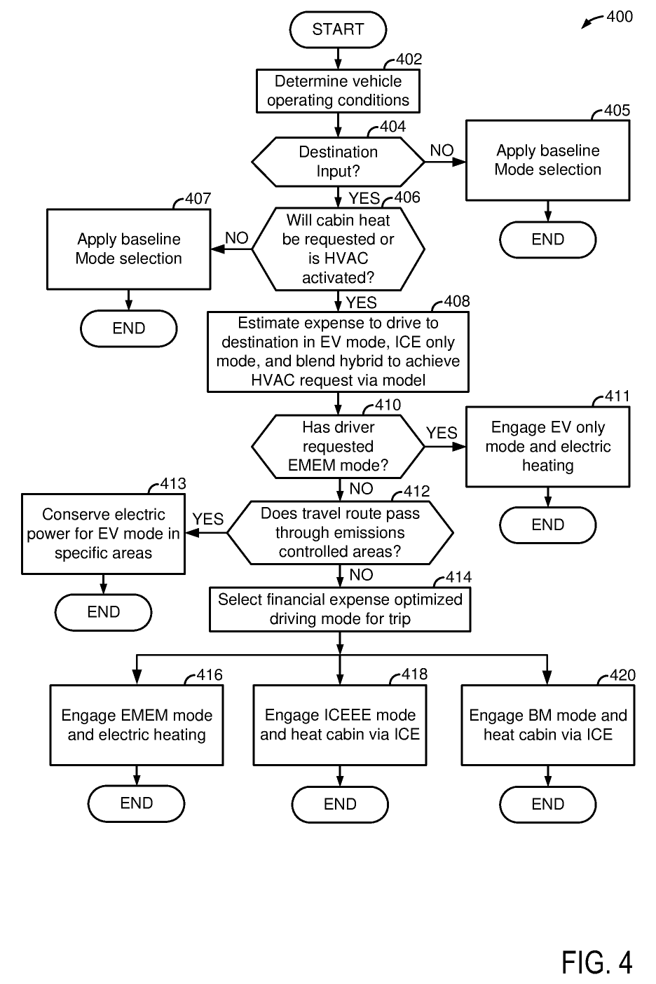

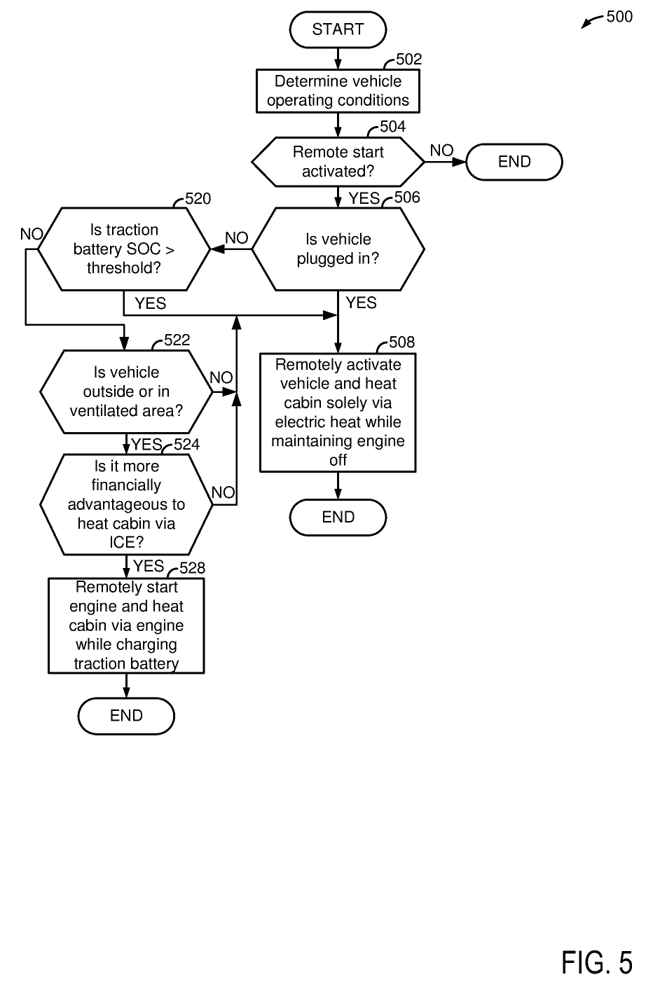

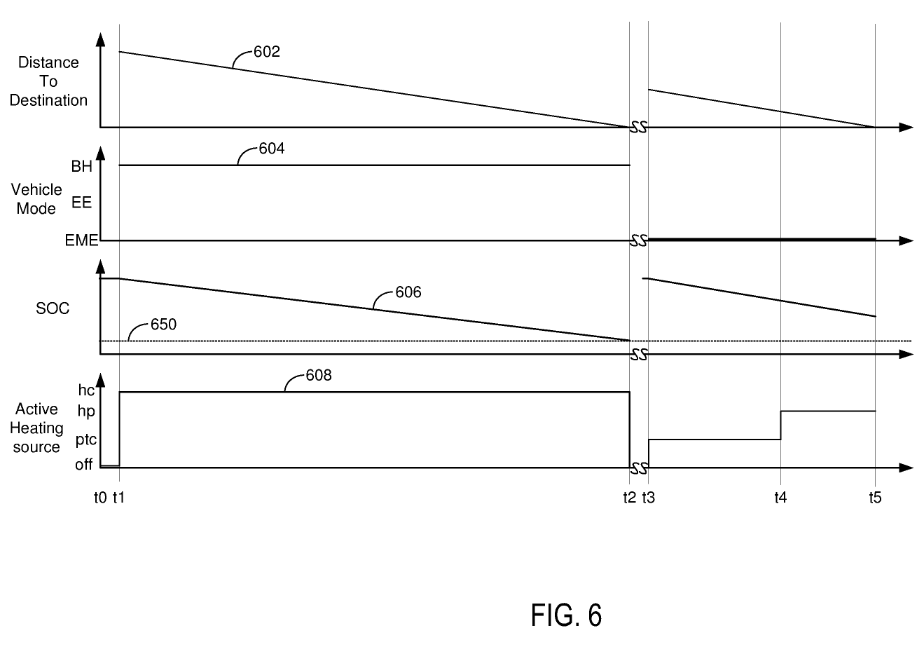

The present description is related to reducing financial expenses of driving a hybrid vehicle to a destination. The hybrid vehicle may include an internal combustion engine and an electric machine for propelling the hybrid vehicle as shown in FIGS. 1 and 2. Further, the hybrid vehicle may have three heat sources for heating a passenger cabin of the hybrid vehicle as shown in FIG. 3. The hybrid vehicle may be operated according to the methods of FIGS. 4 and 5. The hybrid vehicle may operate as shown in the sequence of FIG. 6.

A hybrid vehicle may include an internal combustion engine and an electric machine, thereby allowing the hybrid vehicle to operate in three modes (e.g., electric machine exclusive mode, internal combustion engine exclusive mode, and blended internal combustion engine and electric machine mode). Further, the hybrid vehicle may include a heater core, a positive temperature coefficient (PTC) heater, and a heat pump for heating a passenger cabin. While operating the vehicle in electric machine exclusive mode conserves fuel, it may not be as financially beneficial to operate in electric machine exclusive mode when cabin heating is requested. Therefore, it may be desirable to provide a strategy to determine which vehicle mode to activate during conditions when heating a passenger cabin may be desirable.

The inventors herein has recognized the above-mentioned issues and has developed a vehicle operating method, comprising: activating a mode from a group of modes including an electric machine exclusive driving mode, an internal combustion engine exclusive driving mode, and a blended internal combustion engine and electric machine driving mode in response to financial expense estimates to drive the vehicle to a destination via one of the electric machine exclusive driving mode, the internal combustion engine exclusive driving mode, and the blended internal combustion engine and electric machine driving mode with a passenger cabin climate control system activated for at least a portion of a trip to the destination.

By activating vehicle operating modes in response to financial expense estimates to drive a hybrid vehicle to a destination, it may be possible to provide the technical result of reducing vehicle operating expenses. In addition, it may be possible for a hybrid vehicle to meet emissions and range objectives while reducing vehicle operating expenses.

The present description may provide several advantages. In particular, the approach may reduce vehicle driving expense. Further, the approach may enhance selection and activation of vehicle modes. Additionally, the approach considers a plurality of inputs to select and engage the vehicle modes.

The above advantages and other advantages, and features of the present description will be readily apparent from the following Detailed Description when taken alone or in connection with the accompanying drawings.

Referring to FIG. 1, internal combustion engine 10, comprising a plurality of cylinders, one cylinder of which is shown in FIG. 1, is controlled by electronic engine controller 12. Engine 10 is comprised of cylinder head 35 and block 33, which include combustion chamber 30 and cylinder walls 32. Piston 36 is positioned therein and reciprocates via a connection to crankshaft 40. Flywheel 97 and ring gear 99 are coupled to crankshaft 40. Starter 96 (e.g., low voltage (operated with less than 30 volts) electric machine) includes pinion shaft 98 and pinion gear 95. Pinion shaft 98 may selectively advance pinion gear 95 to engage ring gear 99. Starter 96 may be directly mounted to the front of the engine or the rear of the engine. In some examples, starter 96 may selectively supply torque to crankshaft 40 via a chain. In one example, starter 96 is in a base state when not engaged to the engine crankshaft. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57. Intake valve 52 may be selectively activated and deactivated by valve activation device 59. Exhaust valve 54 may be selectively activated and deactivated by valve activation device 58. Valve activation devices 58 and 59 may be hydraulic and/or electro-mechanical devices.

Fuel injector 66 is shown positioned to inject fuel directly into cylinder 34, which is known to those skilled in the art as direct injection. Fuel injector 66 delivers liquid fuel in proportion to the pulse width from controller 12. Fuel is delivered to fuel injector 66 by a fuel system (not shown) including a fuel tank, fuel pump, and fuel rail (not shown). In one example, a high pressure, dual stage, fuel system may be used to generate higher fuel pressures.

In addition, intake manifold 44 is shown communicating with engine air intake 42. Optional electronic throttle 62 adjusts a position of throttle plate 64 to control air flow from engine air intake 42 to intake manifold 44. In some examples, throttle 62 and throttle plate 64 may be positioned between intake valve 52 and intake manifold 44 such that throttle 62 is a port throttle. Air filter 43 cleans air entering engine air intake 42.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Catalytic converter 70 can include multiple catalyst bricks, in one example. In another example, multiple emission control devices, each with multiple bricks, can be used. Catalytic converter 70 can be a three-way type catalyst in one example. Temperature of catalytic converter 70 (e.g., catalyst) may be monitored via temperature sensor 72.

Controller 12 is shown in FIG. 1 as a conventional microcomputer including: microprocessor unit 102, input/output ports 104, read-excusive memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an driver demand pedal 130 for sensing force applied by human foot 132; a position sensor 154 coupled to caliper control pedal 150 for sensing force applied by foot 152, a measurement of engine manifold pressure (MAP) from pressure sensor 122 coupled to intake manifold 44; an engine position sensor from a position sensor 118 sensing crankshaft 40 position; a measurement of air mass entering the engine from sensor 120; and a measurement of throttle position from sensor 68. Barometric pressure may also be sensed (sensor not shown) for processing by controller 12. In a preferred aspect of the present description, position sensor 118 produces a predetermined number of equally spaced pulses each revolution of the crankshaft from which engine speed (RPM) can be determined.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g., when combustion chamber 30 is at its largest volume) is typically referred to by those of skill in the art as bottom dead center (BDC).

During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion.

During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

FIG. 2 is a block diagram of a vehicle 225 including a powertrain or driveline 200. The powertrain of FIG. 2 includes engine 10 shown in FIG. 1. Powertrain 200 is shown including vehicle system controller 255, engine controller 12, first electric machine controller 252, second electric machine controller 257, transmission controller 254, energy storage device controller 253, climate control system controller 256, human/machine interface 261, and caliper controller 250. The controllers may communicate with each other over controller area network (CAN) 299. Each of the controllers may provide information to other controllers such as power output constraints (e.g., power output of the device or component being controlled not to be exceeded), power input constraints (e.g., power input of the device or component being controlled not to be exceeded), power output of the device being controlled, sensor and actuator data, diagnostic information (e.g., information regarding a degraded transmission, information regarding a degraded engine, information regarding a degraded electric machine, information regarding degraded caplipers). Further, the vehicle system controller 255 may provide commands to engine controller 12, electric machine controller 252, transmission controller 254, and caliper controller 250 to achieve driver input requests and other requests that are based on vehicle operating conditions.

For example, in response to a driver (human or autonomous) releasing a driver demand pedal and vehicle speed, vehicle system controller 255 may request a desired wheel power or a wheel power level to provide a desired rate of vehicle speed reduction. The requested desired wheel power may be provided by vehicle system controller 255 requesting a first vehicle slowing power from electric machine controller 252 and a second vehicle slowing power from engine controller 12, the first and second powers providing a desired driveline slowing power at vehicle wheels 216. Vehicle system controller 255 may also request a caliper power via caliper controller 250. The caliper and vehicle slowing powers may be referred to as negative powers since they slow driveline and wheel rotation. Positive power may maintain or increase speed of the driveline and wheel rotation.

In other examples, the partitioning of controlling powertrain devices may be partitioned differently than is shown in FIG. 2. For example, a single controller may take the place of vehicle system controller 255, engine controller 12, first electric machine controller 252, second electric machine controller 257, transmission controller 254, and caliper controller 250. Alternatively, the vehicle system controller 255 and the engine controller 12 may be a single unit while the electric machine controller 252, the transmission controller 254, and the caliper controller 250 are standalone controllers.

In this example, powertrain 200 may be powered by engine 10 and electric machine 240. In other examples, engine 10 may be omitted. Engine 10 may be started with an engine starting system shown in FIG. 1, via integrated starter/generator BISG 219, or via driveline integrated starter/generator (ISG) 240 also known as an integrated starter/generator. A temperature of BISG 219 may be determined via optional BISG temperature sensor 203. Driveline ISG 240 (e.g., high voltage (operated with greater than 30 volts) electrical machine) may also be referred to as an electric machine, motor, and/or generator. Further, power of engine 10 may be adjusted via power actuator 204, such as a fuel injector, throttle, etc.

Driveline 200 is shown to include an integrated starter/generator (ISG) 219. ISG 219 may be coupled to crankshaft 40 of engine 10 via a chain 231. Alternatively, ISG 219 may be directly coupled to crankshaft 40. ISG 219 may provide a negative torque to driveline 200 when charging higher voltage electric energy storage device 262 (e.g., a traction battery). ISG 219 may also provide a positive torque to rotate driveline 200 via energy supplied by lower voltage electric energy storage device (e.g., a battery or capacitor) 263. In one example, electric energy storage device 262 may output a higher voltage (e.g., 48 volts) than electric energy storage device 263 (e.g., 12 volts). DC/DC converter 245 may allow exchange of electrical energy between high voltage bus 291 and low voltage bus 292. High voltage bus 291 is electrically coupled to inverter 246 and higher voltage electric energy storage device 262. Low voltage bus 292 is electrically coupled to lower voltage electric energy storage device 263 and sensors/actuators/accessories 279. Electrical accessories 279 may include but are not constrained to front and rear windshield resistive heaters, vacuum pumps, climate control fans, and lights. Inverter 246 converts DC power to AC power and vice-versa to enable power to be transferred between ISG 219 and electric energy storage device 262. Likewise, inverter 247 converts DC power to AC power and vice-versa to enable power to be transferred between ISG 240 and electric energy storage device 262.

Vehicle 225 may receive electric power from stationary electric power grid 242 via plug 243. AC or DC power may be input to power converter 244 to transform the power to an appropriate DC voltage level. Power converter 244 may supply DC power to high voltage bus 291.

An engine output power may be transmitted to an input or first side of driveline disconnect clutch 235 through dual mass flywheel 215. Driveline disconnect clutch 236 may be hydraulically actuated via fluid (e.g., oil) that is pressurized via pump 283. A position of valve 282 (e.g., line pressure control valve) may be modulated to control a pressure (e.g., a line pressure) of fluid that may be supplied to driveline disconnect clutch pressure control valve 281. A position of valve 281 may be modulated to control a pressure of fluid that is supplied to driveline disconnect clutch 235. The downstream or second side 234 of disconnect clutch 236 is shown mechanically coupled to ISG input shaft 237.

ISG 240 may be operated to provide power to powertrain 200 or to convert powertrain power into electrical energy to be stored in electric energy storage device 262 in a regeneration mode. ISG 240 is in electrical communication with energy storage device 262. ISG 240 has a higher output power capacity than starter 96 shown in FIG. 1 or BISG 219. Further, ISG 240 directly drives powertrain 200 or is directly driven by powertrain 200. There are no connections, gears, or chains to couple ISG 240 to powertrain 200. Rather, ISG 240 rotates at the same rate as powertrain 200. Electrical energy storage device 262 (e.g., high voltage battery or power source) may be a battery, capacitor, or inductor. The downstream side of ISG 240 is mechanically coupled to the impeller 285 of torque converter 206 via shaft 241. The upstream side of the ISG 240 is mechanically coupled to the disconnect clutch 236. ISG 240 may provide a positive power or a negative power to powertrain 200 via operating as a motor or generator as instructed by electric machine controller 252.

Torque converter 206 includes a turbine 286 to output power to input shaft 270. Input shaft 270 mechanically couples torque converter 206 to automatic transmission 208. Torque converter 206 also includes a torque converter bypass lock-up clutch 212 (TCC). Power is directly transferred from impeller 285 to turbine 286 when TCC is locked. TCC is electrically operated by controller 254. Alternatively, TCC may be hydraulically locked. In one example, the torque converter may be referred to as a component of the transmission.

When torque converter lock-up clutch 212 is fully disengaged, torque converter 206 transmits engine power to automatic transmission 208 via fluid transfer between the torque converter turbine 286 and torque converter impeller 285, thereby enabling torque multiplication. In contrast, when torque converter lock-up clutch 212 is fully engaged, the engine output power is directly transferred via the torque converter clutch to an input shaft 270 of transmission 208. Alternatively, the torque converter lock-up clutch 212 may be partially engaged, thereby enabling the amount of power directly transferred to the transmission to be adjusted. The transmission controller 254 may be configured to adjust the amount of power transmitted by torque converter 212 by adjusting the torque converter lock-up clutch in response to various engine operating conditions, or based on a driver-based engine operation request.

Torque converter 206 also includes pump 283 that pressurizes fluid to operate disconnect clutch 236, forward clutch 210, and gear clutches 211. Pump 283 is driven via impeller 285, which rotates at a same speed as ISG 240.

Automatic transmission 208 includes gear clutches 211 (e.g., gears 1-10) and forward clutch 210. Automatic transmission 208 is a fixed ratio transmission. Alternatively, transmission 208 may be a continuously variable transmission that has a capability of simulating a fixed gear ratio transmission and fixed gear ratios. The gear clutches 211 and the forward clutch 210 may be selectively engaged to change a ratio of an actual total number of turns of input shaft 270 to an actual total number of turns of wheels 216. Gear clutches 211 may be engaged or disengaged via adjusting fluid supplied to the clutches via shift control solenoid valves 209. Power output from the automatic transmission 208 may also be relayed to wheels 216 to propel the vehicle via output shaft 260. Specifically, automatic transmission 208 may transfer an input driving power at the input shaft 270 responsive to a vehicle traveling condition before transmitting an output driving power to the wheels 216. Transmission controller 254 selectively activates or engages TCC 212, gear clutches 211, and forward clutch 210. Transmission controller also selectively deactivates or disengages TCC 212, gear clutches 211, and forward clutch 210.

A frictional force may be applied to wheels 216 by engaging calipers 218. In one example, calipers 218 for wheels 216 may be engaged in response to a human driver pressing their foot on a caliper application pedal (not shown) and/or in response to instructions within caliper controller 250. Further, caliper controller 250 may apply calipers 218 in response to information and/or requests made by vehicle system controller 255. In the same way, a frictional force may be reduced to wheels 216 by disengaging caliper 218 in response to the human driver releasing their foot from a caliper application pedal, caliper controller instructions, and/or vehicle system controller instructions and/or information. For example, calipers may apply a frictional force to wheels 216 via controller 250 as part of an automated engine stopping procedure. A vehicle slowing torque may be determined as a function of caliper pedal position.

In response to a request to increase a speed of vehicle 225, vehicle system controller may obtain a driver demand power or power request from a driver demand pedal or other device. Vehicle system controller 255 then allocates a fraction of the requested driver demand power to the engine and the remaining fraction to the ISG or BISG. Vehicle system controller 255 requests the engine power from engine controller 12 and the ISG power from electric machine controller 252. If the ISG power plus the engine power is less than a transmission input power constraint (e.g., a threshold value not to be exceeded), the power is delivered to torque converter 206 which then relays at least a fraction of the requested power to transmission input shaft 270. Transmission controller 254 selectively locks torque converter clutch 212 and engages gears via gear clutches 211 in response to shift schedules and TCC lockup schedules that may be based on input shaft power and vehicle speed. In some conditions when it may be desired to charge electric energy storage device 262, a charging power (e.g., a negative ISG power) may be requested while a non-zero driver demand power is present. Vehicle system controller 255 may request increased engine power to overcome the charging power to meet the driver demand power.

In response to a request to reduce a speed of vehicle 225 and provide regenerative vehicle slowing, vehicle system controller may provide a negative desired wheel power (e.g., desired or requested powertrain wheel power) based on vehicle speed and caliper control pedal position. Vehicle system controller 255 then allocates a fraction of the negative desired wheel power to the ISG 240 and the engine 10. Vehicle system controller may also allocate a portion of the requested vehicle slowing power to calipers 218 (e.g., desired caliper power). Further, vehicle system controller may notify transmission controller 254 that the vehicle is in regenerative vehicle slowing mode so that transmission controller 254 shifts gears based on a specific shifting schedule to increase regeneration efficiency. Engine 10 and ISG 240 may supply a negative power to transmission input shaft 270, but negative power provided by ISG 240 and engine 10 may be constrained by transmission controller 254 which outputs a transmission input shaft negative power threshold (e.g., not to be exceeded threshold value). Further, negative power of ISG 240 may be constrained (e.g., constrained to less than a threshold negative threshold power) based on operating conditions of electric energy storage device 262, by vehicle system controller 255, or electric machine controller 252. Any portion of desired negative wheel power that may not be provided by ISG 240 because of transmission or ISG constraints may be allocated to engine 10 and/or calipers 218 so that the desired wheel power is provided by a combination of negative power (e.g., power absorbed) via calipers 218, engine 10, and ISG 240.

Accordingly, power control of the various powertrain components may be supervised by vehicle system controller 255 with local power control for the engine 10, transmission 208, electric machine 240, and calipers 218 provided via engine controller 12, electric machine controller 252, transmission controller 254, and caliper controller 250.

As one example, an engine power output may be controlled by adjusting a combination of spark timing, fuel pulse width, fuel pulse timing, and/or air charge, by controlling throttle opening and/or valve timing, valve lift and boost for turbo- or super-charged engines. In the case of a diesel engine, controller 12 may control the engine power output by controlling a combination of fuel pulse width, fuel pulse timing, and air charge. Engine slowing power or negative engine power may be provided by rotating the engine with the engine generating power that is insufficient to rotate the engine. Thus, the engine may generate a slowing power via operating at a low power while combusting fuel, with one or more cylinders deactivated (e.g., not combusting fuel), or with all cylinders deactivated and while rotating the engine. The amount of engine slowing power may be adjusted via adjusting engine valve timing. Engine valve timing may be adjusted to increase or decrease engine compression work. Further, engine valve timing may be adjusted to increase or decrease engine expansion work. In all cases, engine control may be performed on a cylinder-by-cylinder basis to control the engine power output.

Electric machine controller 252 may control power output and electrical energy production from ISG 240 by adjusting electric current flowing to and from field and/or armature windings of ISG as is known in the art.

Transmission controller 254 receives transmission input shaft position via position sensor 271. Transmission controller 254 may convert transmission input shaft position into input shaft speed via differentiating a signal from position sensor 271 or counting a number of known angular distance pulses over a predetermined time interval. Transmission controller 254 may receive transmission output shaft torque from torque sensor 272. Alternatively, sensor 272 may be a position sensor or torque and position sensors. If sensor 272 is a position sensor, controller 254 may count shaft position pulses over a predetermined time interval to determine transmission output shaft velocity. Transmission controller 254 may also differentiate transmission output shaft velocity to determine transmission output shaft rate of speed change. Transmission controller 254, engine controller 12, and vehicle system controller 255, may also receive addition transmission information from sensors 277, which may include but are not constrained to pump output line pressure sensors, transmission hydraulic pressure sensors (e.g., gear clutch fluid pressure sensors), ISG temperature sensors, and BISG temperatures, gear shift lever sensors, and ambient temperature sensors. Transmission controller 254 may also receive requested gear input from gear shift selector 290 (e.g., a human/machine interface device). Gear shift selector 290 may include positions for gears 1-N (where N is an upper gear number), D (drive), and P (park).

Caliper controller 250 receives wheel speed information via wheel speed sensor 221 and vehicle slowing requests from vehicle system controller 255. Caliper controller 250 may also receive caliper pedal position information from position sensor 154 shown in FIG. 1 directly or over CAN 299. Caliper controller 250 may provide vehicle slowing responsive to a wheel power command from vehicle system controller 255. Caliper controller 250 may also provide anti-lock and vehicle stability slowing to increase vehicle stability. As such, caliper controller 250 may provide a wheel power threshold (e.g., a threshold negative wheel power not to be exceeded) to the vehicle system controller 255 so that negative ISG power does not cause the wheel power threshold to be exceeded. For example, if caliper controller 250 issues a negative wheel power threshold of 50 N-m, ISG power is adjusted to provide less than 50 N-m (e.g., 49 N-m) of negative power at the wheels, including accounting for transmission gearing.

Vehicle system controller 255 may receive input data from and provide output data to human/machine interface 160. Human/machine interface 160 may be a touch screen display, key board, or other known interface. Vehicle system controller 255 may provide and display system status information via human/machine interface 160. A human user may input requests for powertrain and passenger cabin climate controls to human/machine interface 160.

Navigation system 265 may receive vehicle position or determine vehicle position from one or more external devices 258 (e.g., global positioning satellites, cellular network towers, etc.). Navigation system 265 may receive a vehicle destination from human/machine interface 160. Navigation system 265, or navigation system 265 in combination with vehicle system controller 255 and/or other vehicle controllers, may estimate an amount of energy to drive the vehicle from its present location to the destination, estimate vehicle fuel consumption along a travel route to the destination, vehicle emissions restricted geographical areas, fuel prices, and electricity prices. External devices 258 may also include devices (e.g., key fob, cellular phone, etc.) for remotely requesting activation and/or starting of vehicle 225. Navigation system 265 and vehicle system controller 255 may communicate with external devices 258 via wireless communication 259.

It may be appreciated that the methods described herein are not constrained to the type of hybrid vehicle that is shown in FIG. 2. The methods may be applied to a variety of different hybrid vehicle types and configurations including but not constrained to power split hybrids, parallel hybrids, and series hybrids.

Referring now to FIG. 3, an example heating system 300 for vehicle 225 is shown. In this example, a climate control system controller 256 may communicate with other controllers (shown in FIG. 2) via CAN 299 as shown in FIG. 2. Climate control system controller 256 may adjust a speed of fan 324 to control a flow of air 350 over PTC heater 326 to heat air in passenger cabin 330. Fan 324 also supplies air 350 to heater core 352 and heat exchanger 354. Climate control system controller 256 may control electric power flow to PTC heater 326, and heat pump 320. Engine 10 may supply heated engine coolant to heater core 352 via conduit 366. Heat pump 320 may supply heat transfer media to heat exchanger 354 when heat pump 320 is activated.

Electric energy storage device 262 is electrically coupled to heat pump 320 and PTC heater 326. Climate control system controller 256 may allow electric current to flow to PTC heater via transistor 367. Likewise, climate control system controller 256 may allow electric current to flow to heat pump via transistor 368.

The system of FIGS. 1-3 provides for a system, comprising: an internal combustion engine; a heater core in fluidic communication with the internal combustion engine; an electric machine; a climate control system including a positive temperature coefficient (PTC) heater and a heat pump; one or more controllers including executable instructions stored in non-transitory memory that cause the one or more controllers to engage a mode from a group of modes including an electric machine exclusive driving mode, an internal combustion engine exclusive driving mode, and a blended internal combustion engine and electric machine driving mode at a beginning of a trip according to a distance to a predetermined destination. In a first example, the system further comprises additional executable instructions that cause the one or more controllers to engage the mode in further response to whether or not passenger cabin heating is predicted to be activated during the trip. In a second example that may include the first example, the system further comprises additional executable instructions that cause the one or more controllers to engage the mode in further response to a human driver request to activate the electric machine exclusive driving mode. In a third example that may include one or both of the first and second examples, the system further comprises additional executable instructions that cause the one or more controllers to engage the mode in further response to vehicle emissions control areas along a route to the predetermined destination. In a fourth example that may include one or more of the first through third examples, the system further comprises additional executable instructions that cause the one or more controllers to estimate financial expenses for engaging each of the electric machine exclusive driving mode, the internal combustion engine exclusive driving mode, and the blended internal combustion engine and electric machine driving mode. In a fifth example that may include one or more of the first through fourth examples, the system includes where the blended internal combustion engine and electric machine driving mode is engaged at a start of the trip in response to the distance is greater than an electric machine exclusive driving mode range. In a sixth example that may include one or more of the first through fifth examples, the system further comprises additional executable instructions that cause the one or more controllers to activate the PTC heater or the heat pump while operating in the electric machine exclusive driving mode in response to ambient temperature.

Referring now to FIG. 4, a method 400 for operating a hybrid vehicle is shown. The method may be at least partially implemented as executable instructions stored in one or more controller’s memory in the system of FIGS. 1-3. Further, the method may include actions taken in the physical world to transform an operating state of the system of FIGS. 1-3. Additionally, the method may provide the operating sequence shown in FIG. 6 and it may include instructions for operating the driveline and climate control system at the conditions described herein. The method of FIG. 4 may be performed at the beginning of a trip to determine available vehicle operating modes during the trip to a destination.

At 402, method 400 determines vehicle operating conditions. Vehicle operating conditions may be determined via receiving inputs as shown in FIGS. 1-3 into one or more controllers. Vehicle operating conditions may include but are not constrained to engine operating state, battery SOC, present vehicle position, vehicle destination, distance to the destination according to a navigation system determined travel route, estimated vehicle energy economy on a trip to the destination, amount of energy consumed by vehicle to reach destination, weather conditions, internal combustion engine efficiency, ambient air temperature, requested passenger cabin temperature, price of chemical fuel, price of electricity, heat pump coefficient of performance, PTC heater coefficient of performance, and geographic areas having engine emissions restrictions. The vehicle destination may be input to via the human/machine interface and commodity prices may be received via wireless communications. Vehicle operating conditions may be determined via onboard vehicle sensors. Method 400 proceeds to 404.

At 404, method 400 judges if a destination for the vehicle has been input to the navigation system and/or one or more controllers. The destination may be input to the human/machine user interface. If method 400 judges that a destination has been input to the navigation system and/or one or more controllers, the answer is yes and method 400 proceeds to 406. Otherwise, the answer is no and method 400 proceeds to 405.

At 405, method 500 applies a baseline strategy for engaging and disengaging the vehicle from electric machine exclusive mode, internal combustion engine exclusive mode, and blended internal combustion engine and electric machine driving mode. In one example, the baseline strategy operates the vehicle in electric machine exclusive mode while SOC is greater than a threshold SOC. The baseline strategy may operate in blended internal combustion engine and electric machine driving mode when battery SOC is being sustained in a predetermined range following battery SOC falling below the threshold SOC. The internal combustion engine exclusive mode may be entered when driver demand is relatively high and when driver demand may be met via the internal combustion engine. Method 400 proceeds to exit.

At 406, method 400 judges whether or not passenger cabin heat will be or activated or is predicted to be activated during a trip to the vehicle’s destination. Method 400 may judge that passenger cabin heat will be activated if at the onset of the trip, passenger cabin heat is requested via the human driver or the climate control system. Further, method 400 may predict that passenger cabin heat will be requested according to ambient temperatures that are forecast along the travel route to the destination. For example, if method 400 determines that ambient temperature will be less than a threshold temperature along the vehicle’s travel route, method 400 may predict that passenger cabin heating will be requested. If method 400 judges that passenger cabin heat will be requested in route to the vehicle’s destination, the answer is yes and method 400 proceeds to 408. Otherwise, the answer is no and method 400 proceeds to 407.

Additionally, at 406, method 400 may determine which of the two electric heaters will be activated if electric heating is chosen to be activated during the trip along the vehicle’s travel route. In one example, if ambient temperature is less than a threshold temperature (e.g., 4 degrees Celsius) the PTC heater may be activated to heat the passenger cabin. However, if ambient temperature is greater than the threshold temperature, the heat pump may be activated to heat the passenger cabin.

At 407, method 500 applies a baseline strategy for engaging and disengaging the vehicle from electric machine exclusive mode, internal combustion engine exclusive mode, and blended internal combustion engine and electric machine driving mode. Method 400 proceeds to exit.

At 408, method 400 estimates whether or not the hybrid vehicle may reach the input destination in the available vehicle operating modes (e.g., electric machine exclusive mode, internal combustion engine exclusive mode, or blended electric machine and internal combustion engine mode) while supplying heat to the passenger cabin and the financial expense of driving the hybrid vehicle to its destination that has been input to the navigation system. Step 408 simulates the energy consumption of the predefined trip using a model of the vehicle and it computes the energy expenses associated with each vehicle operating mode.

In one example, method 400 may estimate whether or not the hybrid vehicle may reach its destination that has been input to the navigation system according to an estimated driving range of the vehicle in each of the available driving modes, traction battery SOC, and an amount of fuel stored in the fuel tank. The driving range for operating the vehicle in electric machine exclusive mode may be estimated based on the vehicle travel route, vehicle speed, and vehicle load. In particular, the travel route may be broken into a plurality of segments and an actual total amount of power for the vehicle to drive through the segments may be determined as a function of vehicle speed and vehicle load. The vehicle speed may be based the posted speed of the particular segment of the travel route and the vehicle load may be estimated based on road grade, vehicle mass, and driver demand. The actual total amount of power for the vehicle to travel through each of the segments of the travel route is estimated by summing the amounts of power for the vehicle to drive through each of the segments that make up the vehicle travel route. The actual total amount of power to propel the vehicle to the destination at the end of the travel route plus an actual total amount of electric power to heat the vehicle’s passenger cabin to a requested temperature using the estimated electric heater (e.g., the PTC heater or the heat pump) for the time duration of the trip may be compared to the total amount of power (adjusted for efficiencies and losses) that the traction battery may provide to the determined electric heat source and to the electric machine to drive the vehicle to the destination. If the actual total amount of battery power that may be provided to the electric machine and to the electric heater is greater than an actual total amount of electric power to propel the vehicle to the destination along the travel route via the electric machine and the actual total amount of electric power to heat the passenger cabin, then method 400 may judge that the hybrid vehicle may reach its destination operating exclusively in electric machine exclusive operating mode for the entire trip. On the other hand, if the actual total amount of battery power that may be provided to the electric machine and to the electric heater is less than an actual total amount of electric power to propel the vehicle to the destination along the travel route via the electric machine and the actual total amount of electric power to heat the passenger cabin, then method 400 may judge that the hybrid vehicle may not reach its destination operating exclusively in electric machine exclusive operating mode for the entire trip. As such, the vehicle may have insufficient driving range capacity to be driven to the destination in electric machine exclusive operating mode. If this is the case, the method 400 may select blended internal combustion engine and electric machine driving mode to reach the vehicle’s destination. Method 400 also determines the financial expense to drive the vehicle to the destination in electric machine exclusive mode with the electric heater activated by dividing the total amount of electric power to drive to the destination by the financial expense of the electric power per unit of power.

In addition, method 400 determines an amount of power for the internal combustion engine to drive the vehicle to its destination and heat the passenger cabin. The amount of power for the vehicle to drive to its destination is determined as previously described. The amount of fuel for the internal combustion engine to generate the power to propel the vehicle to its destination may be determined by estimating the amount of fuel consumed to generate the actual total amount of power for the vehicle to travel each segment along the vehicle’s travel route. The amount of fuel consumed in each segment of the travel route may be estimated from the actual total amount of power for the vehicle to travel a particular travel route segment as a function of engaged transmission gear, driver demand, vehicle speed, vehicle mass, and road load. In one example, a fuel consumption model returns an amount of fuel consumed via the internal combustion engine according to the previously mentioned variables. The expense of driving the vehicle in internal combustion engine exclusive mode may be determined by multiplying the estimated amount of fuel consumed by the vehicle and the price of fuel per unit volume of fuel.

Method 400 may also estimate an amount of electric power that is consumed by the electric machine and an amount of fuel that is consumed by the internal combustion engine to travel the total distance to the destination from the vehicle’s present geographic position. In one example, method 400 may estimate an amount of power that is provided by the electric machine to propel the vehicle along with efficiency and losses based on vehicle speeds and vehicle loads encountered over the route traveled by the vehicle to the destination. For example, method 400 may estimate an actual total amount of electric power consumed via the electric machine to propel the vehicle from the vehicle’s present geographical location to its geographical destination according to when the vehicle operates in a first predetermined vehicle speed and load range as the vehicle travels. The actual total amount of power consumed to propel the vehicle while the vehicle is operating in this speed and load range may be assigned to the electric machine. Similarly, method 400 may estimate an actual total amount of power consumed via the internal combustion engine to propel the vehicle from the vehicle’s present geographical location to its geographical destination according to when the vehicle operates in a second predetermined vehicle speed and load range as the vehicle travels. The actual total amount of power consumed to propel the vehicle while the vehicle is operating in this speed and load range may be assigned to the internal combustion engine. The financial expense for operating the electric machine in this mode may be determined by dividing the amount of electric power consumed by the financial expense of the power per unit power. The financial expense for operating the internal combustion engine in this mode may be determined by dividing the amount of fuel used to generate the power to propel the vehicle via the internal combustion engine by the financial expense of the fuel per unit volume of fuel. Method 400 proceeds to 410.

At 410, method 400 judges whether or not the vehicle’s human driver has requested electric machine exclusive mode (EMEM). The human driver may request electric machine exclusive mode via the human/machine interface. If method 400 judges that the vehicle’s human driver has requested electric machine exclusive mode, the answer is yes and method 400 proceeds to 411. Otherwise, the answer is no and method 400 proceeds to 412.

At 411, method 400 engages electric machine exclusive mode. Method 400 may operate the vehicle in electric machine exclusive mode while battery SOC is greater than a threshold SOC. Method 400 proceeds to exit.

At 412, method 400 judges whether or not the vehicle’s present travel route passes through one or more emissions restricted geographical areas. Emissions restricted areas may include areas where vehicles may be propelled solely via electric machines. The navigation system may include maps that have emissions restricted areas or zones. If method 400 judges that the vehicle’s present travel route passes through an emissions restricted geographical area, the answer is yes and method 400 proceeds to 413. Otherwise, the answer is no and method 400 proceeds to 414.

At 413, method 400 conserves power in the vehicle’s traction battery. In one example, method 400 maintains a threshold SOC in the traction battery by activating the internal combustion engine in response to when the traction battery SOC is within a predetermined range of the threshold SOC. The power in the traction battery is reserved for when the vehicle enters the emissions restricted area. The internal combustion engine is stopped when the vehicle enters the emissions restricted area and the vehicle is propelled via the traction battery and the electric machine. The threshold SOC may be adjusted according to the geographical size of the emissions restricted area. For example, the threshold SOC may be increased for emissions restricted areas that are larger in geographic size and the threshold SOC may be decreased for emissions restricted areas that are smaller in geographic size. Method 400 proceeds to exit.

At 414, method 400 selects the vehicle operating mode that operates the vehicle with a least financial expense according to the estimates for the vehicle to be driven to its destination. For example, if method 400 determines that the vehicle may reach its destination operating in electric machine exclusive mode for $4.00, or the vehicle may reach its destination operating in internal combustion engine exclusive mode for $7.00, or the vehicle may reach its destination operating in blended internal combustion engine and electric machine driving mode for $3.75, method 400 selects blended internal combustion engine and electric machine driving mode since it operates the vehicle at the lowest financial expense to reach the destination. Method 400 proceeds to 416 if method 400 selects electric machine exclusive mode. Method 400 proceeds to 418 if method 400 selects internal combustion engine exclusive mode. Method 400 proceeds to 420 if method 400 selects blended internal combustion engine and electric machine driving mode.

At 416, method 400 engages the electric machine exclusive mode so that the vehicle may be propelled via power that is generated solely via the vehicle’s traction battery and electric machine. In electric machine exclusive mode, driver demand is received via the driver demand pedal and the driver demand is generated to propel the vehicle solely via the vehicle’s traction battery and electric machine. Additionally, method 400 provides heat to the passenger cabin via an electric heating source (e.g., the PTC heater or the heat pump). Method 400 proceeds to exit.

At 418, method 400 engages the internal combustion engine exclusive mode (ICEEE) so that the vehicle may be propelled via power that is generated solely via the vehicle’s internal combustion engine. In internal combustion engine exclusive mode, driver demand is received via the driver demand pedal and the driver demand is generated to propel the vehicle solely via the vehicle’s internal combustion engine. Additionally, method 400 provides heat to the passenger cabin via the internal combustion engine and the heater core (e.g., a heat exchanger that transfers heat from engine coolant to air in the passenger cabin). Method 400 proceeds to exit.

At 420, method 400 engages the blended internal combustion engine and electric machine driving mode so that the vehicle may be propelled via the vehicle’s traction battery and electric machine as well as the internal combustion engine. In blended internal combustion engine and electric machine driving mode, driver demand is received via the driver demand pedal and the driver demand is generated to propel the vehicle via the vehicle’s traction battery and electric machine as well as the internal combustion engine. Additionally, method 400 provides heat to the passenger cabin via the internal combustion engine and the heater core. The internal combustion engine may be activated and deactivated while the vehicle is operating in blended internal combustion engine and electric machine driving mode. Method 400 proceeds to exit.

In this way, a hybrid vehicle may engage different operating modes according to whether or not a passenger cabin heater is or is to be activated during a trip to a destination. Additionally, the hybrid vehicle may engage the different operating modes according to an estimated financial expense to drive the hybrid vehicle to its destination.

Referring now to FIG. 5, a second method 500 for operating a hybrid vehicle is shown. The method may be at least partially implemented as executable instructions stored in one or more controller’s memory in the system of FIGS. 1-3. Further, the method may include actions taken in the physical world to transform an operating state of the system of FIGS. 1-3.

At 502, method 500 determines vehicle operating conditions. Vehicle operating conditions may be determined via receiving inputs as shown in FIGS. 1-3 into one or more controllers. Vehicle operating conditions may include but are not constrained to engine operating state, battery SOC, present vehicle position, vehicle destination, estimated vehicle energy economy on a trip to the destination, amount of energy consumed by vehicle to reach destination, weather conditions, internal combustion engine efficiency, ambient air temperature, requested passenger cabin temperature, price of chemical fuel, price of electricity, heat pump coefficient of performance, PTC heater coefficient of performance, and geographic areas having engine emissions restrictions. The vehicle destination may be input to via the human/machine interface and commodity prices may be received via wireless communications. Vehicle operating conditions may be determined via onboard vehicle sensors. Method 500 proceeds to 504.

At 504, method 500 judges whether or not a remote vehicle start or activation is requested. Method 500 may receive a remote vehicle start request or activation request from a wireless device (e.g., a cellular phone, key fob, etc.). If method 500 judges that a remote vehicle start is requested, the answer is yes and method 500 proceeds to 506. Otherwise, the answer is no and method 500 proceeds to exit.

At 506, method 500 judges whether or not the hybrid vehicle is presently plugged into or electrically coupled to a stationary electric power grid. In one example, method 500 may determine that the hybrid vehicle is plugged into the stationary electric power grid based on electric power flow through a connector or a power converter. If method 500 judges that the vehicle is plugged into the stationary electric power grid, the answer is yes and method 500 proceeds to 508. Otherwise, the answer is no and method 500 proceeds to 520.

At 508, method 500 remotely activates the hybrid vehicle and supplies heat to the passenger cabin via an electric heat source (e.g., PTC heater or heat pump). The hybrid vehicle’s internal combustion engine remains stopped (e.g., not rotating and not combusting fuel). Method 500 proceeds to exit.

At 520, method 500 judge whether or not the hybrid vehicle’s traction battery SOC is greater than a threshold SOC. If method 500 judge that the traction battery SOC is greater than the threshold SOC, the answer is yes and method 500 proceeds to 508. Otherwise, the answer is no and method 500 proceeds to 522.

At 522, method 500 judges whether or not the vehicle is outside or in a ventilated area. Method 500 may apply mapping data, cameras, and/or other sensors to determine whether or not the hybrid vehicle is outside or in a ventilated area. If method 500 judges that the vehicle is outside or in a ventilated area, the answer is yes and method 500 proceeds to 524. Otherwise, the answer is no and method 500 proceeds to 508.

At 524, method 500 judges whether or not it is financially advantageous to heat a passenger cabin via the hybrid vehicle’s internal combustion engine. Method 500 may compare a financial expense of heating the hybrid vehicle’s passenger cabin via an electric heater (e.g., PTC heater or heat pump) to the financial expense of heating the hybrid vehicle’s passenger cabin via heat that is generated via the internal combustion engine and transferred to the passenger cabin via the heater core. For example, method 500 may reference a table that outputs an empirically determined an amount of time it takes to heat the vehicle’s passenger cabin to a requested temperature via an electric heat source using ambient temperature and the requested passenger cabin temperature. The amount of time may be multiplied by the financial expense of operating the electric heat source per unit time to determine the financial expense of heating the passenger cabin via the electric heat source. Similarly, method 500 may reference a table that outputs an empirically determined an amount of time it takes to heat the vehicle’s passenger cabin to a requested temperature via the internal combustion engine using ambient temperature and the requested passenger cabin temperature. The amount of time may be multiplied by the financial expense of operating the internal combustion engine per unit time to determine the financial expense of heating the passenger cabin via the internal combustion engine. If method 500 judges that it is financially advantageous to heat the passenger cabin via the internal combustion engine, the answer is yes and method 500 proceeds to 528. Otherwise, the answer is no and method 500 proceeds to 508.

At 528, method 500 remotely starts the engine via supplying fuel to the engine and cranking the engine. Heat that is generated via operating the engine is applied to heat the passenger cabin. Method 500 proceeds to exit.

In this way, method 500 may select which heating source is desirable to heat the passenger cabin according to financial expenses of operating the electric heat source or the internal combustion engine. Further, method 500 considers the battery SOC and a vehicle’s geographical location (e.g., inside/outside) to determine whether or not to heat the passenger cabin via the internal combustion engine or the electric heat source.

The methods of FIGS. 4 and 5 provide for a vehicle operating method, comprising: activating a mode from a group of modes including an electric machine exclusive driving mode, an internal combustion engine exclusive driving mode, and a blended internal combustion engine and electric machine driving mode in response to financial expense estimates to drive a vehicle to a destination via one of the electric machine exclusive driving mode, the internal combustion engine exclusive driving mode, and the blended internal combustion engine and electric machine driving mode with a passenger cabin climate control system activated for at least a portion of a trip to the destination. In a first example, the vehicle operating method includes where the passenger cabin climate control system includes three different heating sources. In a second example that may include the first example, the vehicle operating method includes where the three different heating sources include a positive temperature coefficient heater, a heat pump, and a heater core. In a third example that may include one or both if the first and second examples, the vehicle operating method includes where activating the mode includes activating the electric machine exclusive driving mode in further response to predicting the vehicle is able to reach the destination without activating the internal combustion engine during the trip. In a fourth example that may include one or more of the first through third examples, the vehicle operating method includes where activating the mode includes activating the blended internal combustion engine and electric machine driving mode in further response to predicting the vehicle is not able to reach the destination without activating the internal combustion engine during the trip. In a fifth example that may include one or more of the first through fourth examples, the vehicle operating method includes where activating the mode includes activating the internal combustion engine exclusive driving mode in further response to a traction battery state of charge being less than a threshold state of charge. In a sixth example that may include one or more of the first through fifth examples, the vehicle operating method includes where the passenger cabin climate control system being activated includes a positive temperature coefficient heater being activated. In a seventh example that may include one or more of the first through sixth examples, the vehicle operating method includes the passenger cabin climate control system being activated includes a heat pump being activated.

The methods of FIGS. 4 and 5 provide for a method for operating a vehicle, comprising: inhibiting an electric machine exclusive driving mode for the vehicle in response to a prediction that an internal combustion engine of the vehicle will be started to drive the vehicle to a predetermined destination with a passenger cabin heating device being activated for at least a portion of a travel route to the predetermined destination. In a first example, the method further comprises heating a passenger cabin via an electrically powered device in response to a remote vehicle start request and the vehicle being in an enclosed area. In a second example that may include the first example, the method further comprises heating a passenger cabin via an electrically powered device in response to a remote vehicle start request and the vehicle being plugged into a power grid. In a third example that may include one or both of the first and second examples, the method further comprises heating a passenger cabin via an electrically powered device in response to a financial comparison between heating the passenger cabin via an electrically power device and heating the passenger cabin via an internal combustion engine. In a fourth example that may include one or more of the first through third examples, the method further comprises activating the electric machine exclusive driving mode in response to a prediction that the internal combustion engine will not be activated to drive the vehicle to the predetermined destination.

Referring now to FIG. 6, an example vehicle operating sequence according to the method of FIG. 4 is shown. The vehicle operating sequence of FIG. 6 may be generated via the system of FIGS. 1-3 in cooperation with the method of FIG. 4. The plots of FIG. 6 are aligned in time and the double SS marks along the horizontal axis represent a break in the time. The break may be short or long in duration.

The first plot from the top of FIG. 6 is a plot that shows the vehicle’s distance to a destination that has been input to the vehicle’s navigation system versus time. The vertical axis represents the distance from the vehicle to the vehicle’s destination and distance increases in the direction of the vertical axis arrow. The horizontal axis represents time and time increases from the left side of the figure to the right side of the figure. Trace 602 represents the distance from the vehicle’s present location to the vehicle’s destination.

The second plot from the top of FIG. 6 is a plot that shows the vehicle’s operating mode versus time. The vertical axis represents the vehicle operating mode (e.g., BH (blended internal combustion engine and electric machine driving mode), EE engine exclusive, ENE electric machine exclusive). The horizontal axis represents time and time increases from the left side of the figure to the right side of the figure. Trace 604 represents the vehicle’s present operating mode.

The third plot from the top of FIG. 6 is a plot that shows the vehicle’s traction battery SOC versus time. The vertical axis represents the SOC and the SOC increases in the direction of the vertical axis arrow. The horizontal axis represents time and time increases from the left side of the figure to the right side of the figure. Trace 606 represents the vehicle’s traction battery SOC. Horizontal line 650 represents a minimum SOC for the vehicle so that degradation of the traction battery due to low battery SOC may be reduced.

The fourth plot from the top of FIG. 6 is a plot that shows the heating source for the passenger cabin versus time. The vertical axis represents the heating source for the passenger cabin (e.g., hc (heater core), hp (heat pump), ptc (PTC heater), and off (no activated heater). The horizontal axis represents time and time increases from the left side of the figure to the right side of the figure. Trace 608 represents the activated heating source.

At time t0, the vehicle is not activated and no destination has been input to the vehicle’s navigation system. The vehicle mode has not been selected and the SOC is high. The vehicle passenger cabin heating source is off.

At time t1, a destination has been input to the vehicle’s navigation system and the vehicle selects and engages blended internal combustion engine and electric machine driving mode in response to the distance to the vehicle’s destination being greater than the vehicle’s capacity to travel the distance in electric machine exclusive mode while heating the passenger cabin. The SOC is high and the passenger cabin is heated via engine heat that is delivered via the heater core.

At time t2, the vehicle is at its destination so the distance to destination is zero and the vehicle mode changes from blended internal combustion engine and electric machine driving mode to off. The SOC is at the minimum SOC level indicating that the electric machine power has been consumed to increase vehicle fuel economy. The active heating source is shut off.

By operating the vehicle in blended internal combustion engine and electric machine driving mode, the vehicle may reach its destination without recharging the traction battery while heating the passenger cabin via heat that is generated by the engine. This operating mode allows the electric machine to reduce fuel consumption via the engine, thereby reducing operating expense of the vehicle.

At time t3, the vehicle is reactivated after being stopped and the distance to the vehicle’s destination is a relatively short distance. Because the distance to the destination is relatively short, the vehicle may be operated in electric machine exclusive mode with electric cabin heating and travel to the vehicle’s destination without recharging the traction battery. Therefore, the vehicle selects electric machine exclusive mode and SOC begins to be reduced. The active heating source to heat the passenger cabin is initially PTC heater because ambient temperature is low, but as ambient temperature increases, the PTC heater is shut off and the heat pump is activated to heat the passenger cabin at time t4.

At time t5, the vehicle is at its destination so the distance to destination is zero and the vehicle mode changes from blended internal combustion engine and electric machine driving mode to off. The SOC remains above the minimum and the heat pump is deactivated.

By operating the vehicle in electric machine exclusive mode, the vehicle may reach its destination without recharging the traction battery while heating the passenger cabin via heat that is generated by an electric source. This operating mode allows the electric machine to propel the vehicle so that engine may not be started, thereby reducing fuel consumption, emissions, and operating expense of the vehicle.

Note that the example control and estimation routines included herein can be used with various engine and/or vehicle system configurations. Further, the methods described herein may be a combination of actions taken by a controller in the physical world and instructions within the controller. At least portions of the control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller

This concludes the description. The reading of it by those skilled in the art would bring to mind many alterations and modifications without departing from the spirit and the scope of the description. For example, I3, I4, I5, V6, V8, V10, and V12 engines operating in natural gas, gasoline, diesel, or alternative fuel configurations could use the present description to advantage.

1. A vehicle operating method, comprising:
activating a mode from a group of modes including an electric machine exclusive driving mode, an internal combustion engine exclusive driving mode, and a blended internal combustion engine and electric machine driving mode in response to financial expense estimates to drive a vehicle to a destination via one of the electric machine exclusive driving mode, the internal combustion engine exclusive driving mode, and the blended internal combustion engine and electric machine driving mode with a passenger cabin climate control system activated for at least a portion of a trip to the destination.

2. The vehicle operating method of claim 1, where the passenger cabin climate control system includes three different heating sources.

3. The vehicle operating method of claim 2, where the three different heating sources include a positive temperature coefficient heater, a heat pump, and a heater core.

4. The vehicle operating method of claim 1, where activating the mode includes activating the electric machine exclusive driving mode in further response to predicting the vehicle is able to reach the destination without activating an internal combustion engine during the trip.

5. The vehicle operating method of claim 1, where activating the mode includes activating the blended internal combustion engine and electric machine driving mode in further response to predicting the vehicle is not able to reach the destination without activating an internal combustion engine during the trip.

6. The vehicle operating method of claim 1, where activating the mode includes activating the internal combustion engine exclusive driving mode in further response to a traction battery state of charge being less than a threshold state of charge.

7. The vehicle operating method of claim 1, where the passenger cabin climate control system being activated includes a positive temperature coefficient heater being activated.

8. The vehicle operating method of claim 1, the passenger cabin climate control system being activated includes a heat pump being activated.

9. A system, comprising:
an internal combustion engine;
a heater core in fluidic communication with the internal combustion engine;
an electric machine;
a climate control system including a positive temperature coefficient (PTC) heater and a heat pump;
one or more controllers including executable instructions stored in non-transitory memory that cause the one or more controllers to engage a mode from a group of modes including an electric machine exclusive driving mode, an internal combustion engine exclusive driving mode, and a blended internal combustion engine and electric machine driving mode at a beginning of a trip according to a distance to a predetermined destination.

10. The system of claim 9, further comprising additional executable instructions that cause the one or more controllers to engage the mode in further response to whether or not passenger cabin heating is predicted to be activated during the trip.

11. The system of claim 10, further comprising additional executable instructions that cause the one or more controllers to engage the mode in further response to a human driver request to activate the electric machine exclusive driving mode.

12. The system of claim 11, further comprising additional executable instructions that cause the one or more controllers to engage the mode in further response to vehicle emissions control areas along a route to the predetermined destination.

13. The system of claim 9, further comprising additional executable instructions that cause the one or more controllers to estimate financial expenses for engaging each of the electric machine exclusive driving mode, the internal combustion engine exclusive driving mode, and the blended internal combustion engine and electric machine driving mode.

14. The system of claim 9, where the blended internal combustion engine and electric machine driving mode is engaged at a start of the trip in response to the distance is greater than an electric machine exclusive driving mode range.

15. The system of claim 9, further comprising additional executable instructions that cause the one or more controllers to activate the PTC heater or the heat pump while operating in the electric machine exclusive driving mode in response to ambient temperature.

16. A method for operating a vehicle, comprising:
inhibiting an electric machine exclusive driving mode for the vehicle in response to a prediction that an internal combustion engine of the vehicle will be started to drive the vehicle to a predetermined destination with a passenger cabin heating device being activated for at least a portion of a travel route to the predetermined destination.

17. The method of claim 16, further comprising heating a passenger cabin via an electrically powered device in response to a remote vehicle start request and the vehicle being in an enclosed area.

18. The method of claim 16, further comprising heating a passenger cabin via an electrically powered device in response to a remote vehicle start request and the vehicle being plugged into a power grid.

19. The method of claim 16, further comprising heating a passenger cabin via an electrically powered device in response to a financial comparison between heating the passenger cabin via an electrically power device and heating the passenger cabin via the internal combustion engine.

20. The method of claim 16, further comprising activating the electric machine exclusive driving mode in response to a prediction that the internal combustion engine will not be activated to drive the vehicle to the predetermined destination.
